(19) United States
(12) Patent Application Publication
(10) Pub. No.: US 2016/0247429 A1
(43) Pub. Date: Aug. 25, 2016

(54) METHOD AND SYSTEM FOR TESTING OLED DISPLAY DEVICE

(71) Applicant: BOE TECHNOLOGY GROUP CO., LTD., Beijing (CN)

(72) Inventors: Yanzhao LI, Beijing (CN); Gang WANG, Beijing (CN); Jingang FANG, Beijing (CN); Hui ZHAO, Beijing (CN); Qijun ZHA, Beijing (CN)

(73) Assignee: BOE TECHNOLOGY GROUP CO., LTD., Beijing (CN)

(21) Appl. No.: 14/435,766

(22) PCT Filed: Sep. 29, 2014
(86) PCT No.: PCT/CN2014/087788

§ 371 Date: Apr. 15, 2015

(30) Foreign Application Priority Data
Mar. 31, 2014 (CN) 201410127150.9

(51) Int. Cl. G09G 3/00

(52) U.S. Cl. CPC G09G 3/006

(57) ABSTRACT

The present disclosure provides a method and a system for testing an OLED display device. The method includes steps of: applying a testing signal to the to-be-tested OLED display device; acquiring a measured distribution image for a testing region of the OLED display device to which the testing signal is applied; comparing the measured distribution image with a corresponding calibrated distribution image so as to obtain a comparison result; determining whether or not there is a back plate abnormal point at the testing region in accordance with the comparison result; and when the comparison result indicates that there is a back plate abnormal point at the testing region, determining a position of the back plate abnormal point on the OLED display device.

### CROSS-REFERENCE TO RELATED APPLICATION

This application is the U.S. national phase of PCT Application No. PCT/CN2014/087788 filed on Sep. 29, 2014, which claims a priority of the Chinese Patent Application No. 201410127150.9 filed on Mar. 31, 2014, the disclosures of which are incorporated in their entirety by reference herein.

### TECHNICAL FIELD

The present disclosure relates to the field of organic light-emitting diode (OLED) display device testing technology, in particular to a method and a system for testing an OLED display device.

### BACKGROUND

An active matrix organic light-emitting diode (AMOLED) panel has been recognized as a core technology for the next-generation display device. During the manufacture thereof, a process similar to a liquid crystal display (LCD) is used, and it is also required to test a thin film transistor (TFT) back plate. However, it is impossible to test an OLED back plate by a liquid crystal simulation method which may be used to test an LCD back plate. In the related art, the OLED back plate is usually tested by a secondary electronic imaging method or an electrical measurement method. The secondary electronic imaging method is of limited precision, while in electrical measurement method, the design and process for the OLED back plate are highly demanded. In addition, it is required to perform data analysis and thus these methods are less intuitive.

The final testing of the OLED back plate and the subsequent processes such as repairing are significantly constrained by these defects in the existing methods for testing the OLED back plate.

### SUMMARY

An object of the present disclosure is to provide a method and a system for testing an OLED display device, so as to improve testing efficiency and testing intuition for the OLED display device.

In one aspect, the present disclosure provides in one embodiment a method for testing an OLED display device, including steps of:

applying a testing signal to the to-be-tested OLED display device;

acquiring a measured distribution image for a testing region of the OLED display device to which the testing signal is applied;

comparing the measured distribution image with a corresponding calibrated distribution image so as to obtain a comparison result;

determining whether or not there is a back plate abnormal point at the testing region in accordance with the comparison result; and

when the comparison result indicates that there is a back plate abnormal point at the testing region, determining a position of the back plate abnormal point on the OLED display device.

Alternatively, the measured distribution image is an infrared spectrum distribution image or a heat distribution image.

Alternatively, the step of acquiring the measured distribution image for the testing region of the OLED display device to which the testing signal is applied includes:

dividing the testing region of the OLED display device into a plurality of detection regions; and

acquiring the measured distribution images for the detection regions sequentially.

Alternatively, the testing region of the OLED display device is a single detection region.

Alternatively, the testing region of the OLED display device is a pixel region of the OLED display device, or a combined region consisting of a pixel region of the OLED display device and a peripheral circuit region of the OLED display device.

Alternatively, the calibrated distribution image is a theoretical distribution image for a standard OLED display device to which the testing signal is applied, or a distribution image for a standard OLED display device to which the testing signal is not applied, or a distribution image for the to-be-tested OLED display device to which the testing signal is not applied. The standard OLED display device is of a structure identical to the to-be-tested OLED display device, and free of circuit defects.

Alternatively, when the calibrated distribution image is the distribution image for the to-be-tested OLED display device to which the testing signal is not applied, prior to the step of applying the testing signal to the to-be-tested OLED display device, the method further includes steps of:

acquiring a distribution image for the testing region of the OLED display device; and

taking the distribution image as the calibrated distribution image and storing the calibrated distribution image.

Alternatively, prior to the step of applying the testing signal to the to-be-tested OLED display device, the method further includes steps of:

placing the OLED display device onto a testing platform;

acquiring an alignment mark of the OLED display device by an imaging device;

aligning the OLED display device in accordance with the alignment mark; and

attaching an OLED circuit emulation board onto the OLED display device.

Alternatively, the step of determining the position of the back plate abnormal point on the OLED display device includes:

acquiring the alignment mark of the to-be-tested OLED display device acquired by the imaging device during the alignment, generating a coordinate system of the to-be-tested OLED display device in accordance with the alignment mark, and when it is determined that there is a back plate abnormal point in the measured distribution image, determining the position of the back plate abnormal point on the OLED display device in accordance with the coordinate system.

Alternatively, when the comparison result indicates that there is a back plate abnormal point at the testing region, the method further includes a step of marking the back plate abnormal point in the measured distribution image.

Alternatively, when the comparison result indicates that there is a back plate abnormal point at the testing region, the method further includes steps of matching image information about the back plate abnormal point in the measured distribution image with a previously stored back plate abnormal point information base, preliminarily determining a cause for the back plate abnormal point, and outputting the cause.

Alternatively, subsequent to the step of determining the position of the back plate abnormal point on the OLED display device, the method further includes a step of moving a microscope device to the position for observation.

Alternatively, the OLED display device is an OLED TFT back plate, or an evaporated or printed OLED display panel, or an OLED display module where the circuit assembly has been finished.

In another aspect, the present disclosure provides in one embodiment a system for testing an OLED display device, including:

a testing signal applying device configured to apply a testing signal to the to-be-tested OLED display device;

an imaging device configured to acquire and display a measured distribution image for a testing region of the OLED display device to which the testing signal is applied; and

a processor configured to compare the measured distribution image with a corresponding calibrated distribution image so as to obtain comparison result, determine whether or not there is a back plate abnormal point at the testing region in accordance with the comparison result, and when the comparison result indicates that there is a back plate abnormal point at the testing region, determine a position of the back plate abnormal point on the OLED display device.

Alternatively, the imaging device is a charge coupled device (CCD) imager capable of acquiring heat information or infrared information.

Alternatively, the system further includes a testing platform. The imaging device is further configured to acquire an alignment mark of the OLED display device placed on the testing platform, and the processor is further configured to align the OLED display device in accordance with the alignment mark.

Alternatively, the system further includes:

a microscope device; and

a controller configured to move the microscope device to the position for observation.

Alternatively, the system further includes a back plate abnormal point information base including image information about various back plate abnormal points in the measured distribution image and a cause corresponding to the image information.

According to the embodiments of the present disclosure, it is able to intuitively display a testing result of the OLED display device through a physical image, thereby to rapidly determine the back plate abnormal point, improve the testing efficiency and the testing intuition without any complex testing circuits, and reduce the cost for testing.

### BRIEF DESCRIPTION OF THE DRAWINGS

FIG. 1 is a flow chart of a method for testing an OLED display device according to one embodiment of the present disclosure;

FIG. 2 is a schematic view showing a to-be-tested AMOLED-TFT back plate according to one embodiment of the present disclosure;

FIG. 3 is a schematic view showing a measured distribution image for the to-be-tested AMOLED-TFT back plate in FIG. 2;

FIG. 4 is schematic view showing a system for testing an OLED display device according to one embodiment of the present disclosure;

FIG. 5 is another schematic view showing the system for testing the OLED display device according to one embodiment of the present disclosure; and

FIG. 6 is yet another schematic view showing the system for testing the OLED display device according to one embodiment of the present disclosure.

### DETAILED DESCRIPTION

An OLED display device is driven by current, so a large amount of heat may be generated during its operation, and its infrared spectrum distribution when it operates electrically is significantly different from the infrared spectrum distribution when it does not operate electrically. In the following embodiments of the present disclosure, the OLED display device is tested just on the basis of a principle that the infrared spectrum of the OLED display device is significantly changed during its operation. To be specific, a measured distribution image for a to-be-tested OLED display device to which a testing signal is applied is acquired and then compared with a corresponding calibrated distribution image so as to obtain a comparison result, then whether or not there is a back plate abnormal point on the to-be-tested OLED display device is determined in accordance with the comparison result, and then a position of the back plate abnormal point is determined when there is the back plate abnormal point, so as to observe and determine a defect.

In order to make the objects, the technical solutions and the advantages of the present disclosure more apparent, the present disclosure will be described hereinafter in conjunction with the drawings and embodiments.

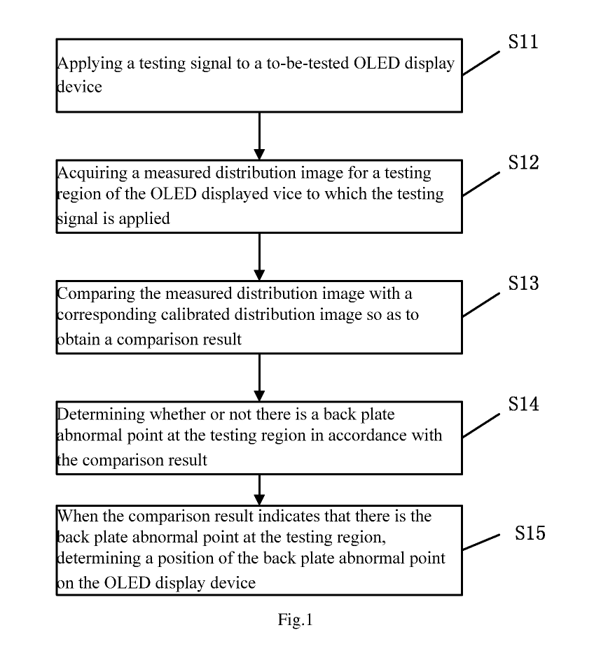

Referring to FIG. 1, which is a flow chart of a method for testing an OLED display device according to one embodiment of the present disclosure, the method includes the following steps.

Step S11: applying a testing signal to the to-be-tested OLED display device.

The to-be-tested OLED display device may an OLED TFT back plate, or an evaporated or printed OLED display panel, or an OLED display module where the circuit assembly has been finished. The OLED display panel includes the OLED TFT back plate and an OLED light-emitting element. The OLED display module includes the OLED display panel and a peripheral circuit.

The testing signal may include voltage signals applied to a gate line, a data line and a power source line (VDD line) of the OLED display device, respectively.

When the OLED display device includes a compensating circuit, the testing signals may include voltage signals applied to the gate line, the data line, the power source line, a power source cathode line (VSS line), a S2 line and a S3 line (S2 and S3 are sequence control signals for the compensating circuit) of the OLED display device, respectively.

It is obvious that, when the OLED display device has a different circuit structure, the other testing signal may also be used, which are not particularly defined herein.

Step S12: acquiring a measured distribution image for a testing region of the OLED display device to which the testing signal is applied. The measured distribution image is an infrared spectrum distribution image or a heat distribution image.

The testing region of the OLED display device may be a pixel region of the OLED display device, or a combined region consisting of a pixel region of the OLED display device and a peripheral circuit region of the OLED display device. At the pixel region, there mainly exist such circuit elements as a TFT, a capacitor, a pixel electrode, a gate line, a data line, a VDD line, and a VSS line. At the peripheral circuit region, there mainly exist a row driving circuit, a column driving circuit and any other circuit portion. The other circuit portion may include an ESD (electronic static discharge) circuit configured to prevent the OLED display device from being damaged due to static electricity.

To be specific, the measured distribution image for the testing region of the OLED display device to which the testing signal is applied may be acquired by an imaging device. The imaging device may be a photon-inductive infrared CCD (charge coupled device) imager, or a heat-inductive infrared CCD imager, or a photon-and-heat-inductive infrared imager, or any other CCD imager capable of acquiring heat information or infrared information.

To be specific, a distribution image generated by the imaging device may be directly used as the measured distribution image.

In addition, the distribution image generated by the imaging device may also be processed (e.g., a plurality of distribution images may be assembled into one distribution image), and then the processed image may be used as the measured distribution image.

Step S13: comparing the measured distribution image with a corresponding calibrated distribution image so as to obtain a comparison result. The calibrated distribution image may be a theoretical distribution image for a standard OLED display device to which the testing signal is applied, or a distribution image for a standard OLED display device to which the testing signal is not applied, or a distribution image for the to-be-tested OLED display device to which the testing signal is not applied. The standard OLED display device is of a structure identical to the to-be-tested OLED display device and free of a circuit defect.

Step S14: determining whether or not there is a back plate abnormal point at the testing region in accordance with the comparison result.

Step S15: when the comparison result indicates that there is a back plate abnormal point at the testing region, determining a position of the back plate abnormal point on the OLED display device.

According to the method in the embodiment of the present disclosure, it is able to display a testing result of the OLED display device intuitively through a physical image, thereby to rapidly determine the back plate abnormal point, improve the testing efficiency and the testing intuition without any complex testing circuit, and reduce the cost for testing.

The OLED display device in the embodiments of the present disclosure may be an AMOLED display device, or any other OLED display device.

In order to improve the testing precision, in an embodiment of the present disclosure, the to-be-tested OLED display device may be placed on a testing platform, and then aligned with the imaging device for acquiring the distribution image.

In other words, prior to the step of applying the testing signal to the OLED display device, the method further includes steps of:

placing the OLED display device onto the testing platform

acquiring the alignment mark of the OLED display device by the imaging device;

aligning the OLED display device in accordance with the alignment mark; and

attaching an OLED circuit emulation board onto the OLED display device.

When the to-be-tested OLED display device is of a large size, it is very difficult for the imaging device to acquire a complete image for the testing region of the OLED display device at a time. In the embodiments of the present disclosure, when acquiring the measured distribution image for the testing region of the OLED display device, the testing region of the OLED display device is divided into a plurality of detection regions, and the measured distribution images for the detection regions are acquired sequentially. Alternatively, the detection regions are of an identical size.

When the to-be-tested OLED display device is of a small size and the complete image for the testing region of the to-be-tested OLED display device may be acquired at a time, it is unnecessary to divide the testing region, i.e., the testing region is a single detection region.

When the testing region is divided into a plurality of detection regions, there may exist in the embodiments of the present disclosure a plurality of calibrated distribution images in one-to-one correspondence with the detection regions. At this time, the measured distribution image for each detection region may be compared with the calibrated distribution image corresponding to the detection region.

There may also exist only one calibrated distribution image in the embodiments of the present disclosure, and at this time, the measured distribution images for all the detection regions of the to-be-tested OLED display device may be assembled to form a complete image, and then the complete image may be compared with the calibrated distribution image.

When the calibrated distribution image is the distribution image for the to-be-tested OLED display device to which the testing signal is not applied, prior to the step of applying the testing signal to the OLED display device, the method further includes steps of:

acquiring the distribution image for the testing region of the OLED display device; and

taking the distribution image as the calibrated distribution image and storing the calibrated distribution image.

In addition, prior to acquiring the distribution image for the testing region of the OLED display device to which the testing signal is not applied, it is also required to align the OLED display device (the way for alignment has been described hereinbefore, and thus will not be repeated herein).

In the embodiments of the present disclosure, the position of the back plate abnormal point on the to-be-tested OLED display device may be determined by acquiring the alignment marks (usually there are several alignment marks) of the to-be-tested OLED display device acquired by the imaging device during the alignment, generating a coordinate system of the to-be-tested OLED display device in accordance with the alignment marks, and when it is determined that there is a back plate abnormal point in the measured distribution image, determining the position of the back plate abnormal point on the OLED display device in accordance with the coordinate system. It is obvious that, the coordinate system may also be used for the measured distribution image acquired by the imaging device.

It is obvious that, in the embodiments of the present disclosure, any other method may also be used to determine the position of the back plate abnormal point on the OLED display device.

For ease of observation, in the embodiments of the present disclosure, when the comparison result indicates that there is a back plate abnormal point at the testing region, the method may further include a step of marking the back plate abnormal points in the measured distribution image.

In order to determine a cause for the back plate abnormal point and thereby to facilitate the repair of the OLED display device, in the embodiments of the present disclosure, subsequent to the step of determining the position of the back plate abnormal point on the OLED display device, the method further includes a step of moving a microscope device to the position for observation.

In addition, in order to improve the testing efficiency, in the embodiments of the present disclosure, a back plate abnormal point information base may be stored in advance. The back plate abnormal point information base includes image information about various back plate abnormal points in the measured distribution image, and a cause corresponding to the image information. When the comparison result indicates that there is a back plate abnormal point at the testing region, the image information about the back plate abnormal point in the measured distribution image is matched with the stored back plate abnormal point information base, so as to preliminarily determine a cause for the back plate abnormal point and output the cause. It is obvious that, this cause is merely for reference, and it is also required to observe a real object by a microscope device so as to determine the cause accurately.

The method for testing the OLED display device in the embodiments of the present disclosure will be described hereinafter by taking the AMOLED-TFT back plate as an example.

### First Embodiment

In this embodiment, the to-be-test OLED display device is an AMOLED-IGZO (indium gallium zinc oxide)-TFT back plate of a 2T1C-based structure (i.e., a structure including two transistors T and one capacitor C).

The method for testing the OLED display device in this embodiment includes the following steps.

Step S21: placing the to-be-tested IGZO-TFT back plate where an array substrate process has been completed onto the testing platform.

Step S22: acquiring an alignment mark of the IGZO-TFT back plate by a photon-inductive infrared CCD imager, and aligning the IGZO-TFT back plate in accordance with the alignment mark.

Step S23: after the alignment, attaching an OLED circuit emulation board onto the IGZO-TFT back plate, connecting a circuit element on the IGZO-TFT back plate with a circuit element on the OLED circuit emulation board after the attachment so as to form a testing circuit, sequentially scanning by the photon-inductive infrared CCD imager the IGZO-TFT back plate from a first detection region (e.g., a first portion of region AA (an active pixel region)) to the last detection region (e.g., a peripheral circuit region of the back plate), acquiring a calibrated distribution image for each detection region, and storing the calibrated distribution image.

Step S24: applying a testing signal to the IGZO-TFT back plate (e.g., applying a voltage of 10V to the gate line and the data line and applying a voltage of 12V to the VDD line), scanning again by the photon-inductive infrared CCD imager the IGZO-TFT back plate from the first detection region to the last detection region in the case that the testing signal is maintained, acquiring a measured distribution image for each detection region, and storing the measured distribution image.

Step S25: comparing the measured distribution image with the corresponding calibrated distribution image to obtain a comparison result, and when the comparison result indicates that there is a back plate abnormal point at the testing region of the IGZO-TFT back plate, determining a position of the back plate abnormal point on the IGZO-TFT back plate.

Step S26: moving an optical microscope to the determined position for observation, so as to determine a cause for the back plate abnormal point.

### Second Embodiment

In this embodiment, the to-be-tested OLED display device is an AMOLED-LTPS (low temperature poly-silicon)-TFT back plate with a 4T2C-based (i.e., including four transistors T and two capacitors C) compensating circuit.

In this embodiment, the method for testing the OLED display device includes the following steps.

Step 31: placing the to-be-tested LTPS-TFT back plate where an array substrate process has been completed onto the testing platform.

Step S32: acquiring an alignment mark of the LTPS-TFT back plate by a photon-inductive infrared CCD imager, and aligning the LTPS-TFT back plate in accordance with the alignment mark.

Step S33: after the alignment, attaching an OLED circuit emulation board onto the LTPS-TFT back plate, connecting a circuit element on the LTPS-TFT back plate with a circuit element on the OLED circuit emulation board after the attachment so as to form a testing circuit, sequentially scanning by the photon-inductive infrared CCD imager the LTPS-TFT back plate from a first detection region (e.g., a first portion of region AA (an active pixel region)) to the last detection region (e.g., a peripheral circuit region of the back plate), acquiring a calibrated distribution image for each detection region, and storing the calibrated distribution image.

Step S34: applying a testing signal to the LTPS-TFT back plate (e.g., applying a voltage of 10V to the gate line and the VDD line, enabling the VSS line to be grounded, applying sequence voltage signals to the line S2 and the line S3, and applying grayscale signals to the data lines), scanning again by the photon-inductive infrared CCD imager the LTPS-TFT back plate from the first detection region to the last detection region in the case that the testing signal is maintained, acquiring a measured distribution image for each detection region, and storing the measured distribution image.

Step S35: comparing the measured distribution image with the corresponding calibrated distribution image to obtain a comparison result, and when the comparison result indicates that there is a back plate abnormal point at the testing region of the LTPS-TFT back plate, determining a position of the back plate abnormal point on the LTPS-TFT back plate.

Step S36: moving an optical microscope to the determined position for observation, so as to determine a cause for the back plate abnormal point.

In the embodiments of the present disclosure, the to-be-tested AMOLED-TFT back plate may include an a-Si TFT back plate, a LTPS TFT back plate, an oxide (e.g., IGZO) TFT back plate, and any other AMOLED-TFT back plate manufactured by various semiconductor materials.

In the embodiments of the present disclosure, the to-be-tested AMOLED-TFT back plate may be of a 2T1C-based or 4T2C-based structure, or any other pixel structures.

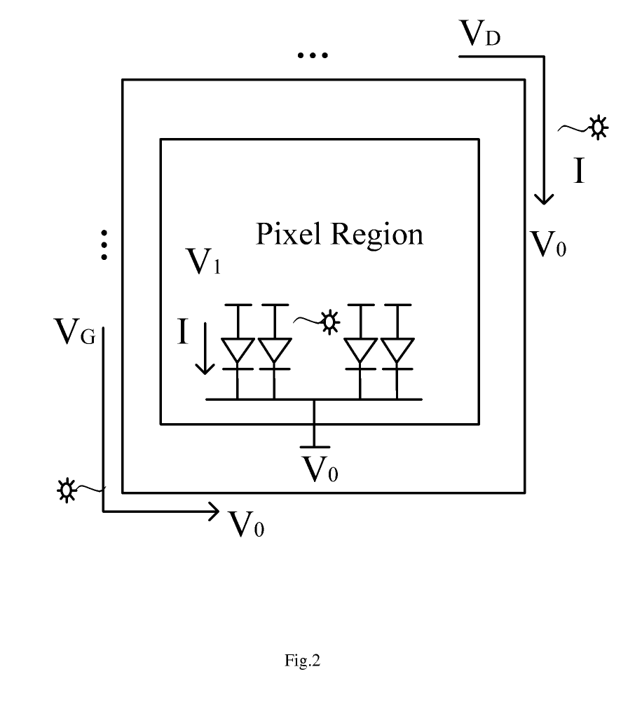

Referring to FIG. 2, which is a schematic view showing the to-be-tested AMOLED TFT back plate according to one embodiment of the present disclosure, the AMOLED TFT back plate includes a pixel region, and a peripheral circuit region at a periphery of an OLED block. In FIG. 2, VD, VG, V1 and V0 represent testing signals applied to the AMOLED TFT back plate, respectively. VD represents the testing signal applied to the data line, VG represents the testing signal applied to the gate line, V1 represents the testing signal applied to the VDD line, and V0 represents the testing signal applied to the VSS line. I represents a current generated after the testing signal is applied.

In this embodiment, merely the pixel region is tested.

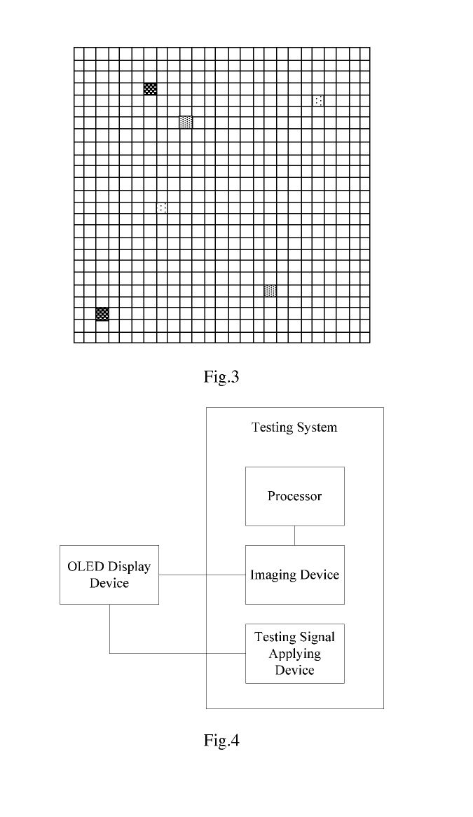

Referring to FIG. 3, which is a schematic view showing the measured distribution image for the to-be-tested AMOLED TFT back plate in FIG. 2, each grid represents one pixel. As shown in FIG. 3, some pixels are in a color different from the other pixels (in the figure, different hatched patterns represent different colors). These abnormal pixels are just the back plate abnormal points mentioned above.

To be specific, different pixel states may be represented by different colors. For example, blue pixels represent normal pixel regions which make up a majority of the back plate, red pixels represents regions where a serious current leakage occurs, yellow pixels represent regions where a micro-short circuit occurs, and cyan pixels represents regions where an open circuit occurs. In this way, a tester may preliminarily determine the cause for the back plate abnormal point in accordance with its color in the measured distribution image.

After the cause for the back plate abnormal point is determined, the OLED display device may be repaired, redone or abandoned in accordance with the practical situation. For example, when a short circuit occurs for an individual pixel, a short circuit point may be cut off by a laser, and when parts of metal lines are open-circuited, metal may be provided by a micro-sputtering process so as to connect the broken metal lines.

In the above embodiments, when the to-be-tested OLED display device is an OLED display panel, it may be tested in vacuum, so as to facilitate the repair after the testing.

The present disclosure further provides in one embodiment a system for testing an OLED display device which, as shown in FIG. 4, includes:

a testing signal applying device, configured to apply a testing signal to the to-be-tested OLED display device;

an imaging device, configured to acquire and display a measured distribution image for a testing region of the OLED display device to which the testing signal is applied; and

a processor, configured to compare the measured distribution image with a corresponding calibrated distribution image so as to obtain comparison result, determine whether or not there is a back plate abnormal point at the testing region in accordance with the comparison result, and when the comparison result indicates that there is a back plate abnormal point at the testing region, determine a position of the back plate abnormal point on the OLED display device.

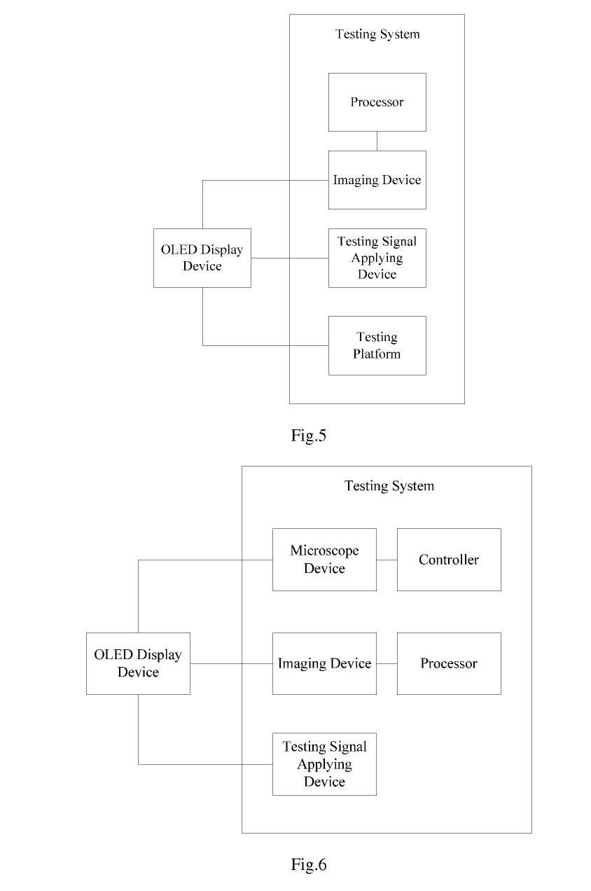

Alternatively, as shown in FIG. 5, the system may further include a testing platform. The imaging device is further configured to acquire an alignment mark of the OLED display device placed on the testing platform, and the processor is further configured to align the OLED display device in accordance with the alignment mark.

The imaging device in the embodiments of the present disclosure may be a photon-inductive infrared CCD imager, or a heat-inductive infrared CCD imager, or a photon-and-heat-inductive infrared CCD imager, or any other CCD imager capable of acquiring heat information or infrared information.

The processor may process, e.g., intercept, assemble and enlarge, the acquired distribution image, and these processings may be executed by hardware, or a combination of hardware and software.

Alternatively, as shown in FIG. 6, the system may further include a microscope device, and a controller configured to move the microscope device to the position for observation. The microscope device may be an optical microscope, an infrared or UV microscope, Raman spectrometer, or any other microscope device.

In addition, in order to repair the OLED display device with defects, the system may further include a back plate repairing device, e.g., a laser for cutting and melting the metal lines, or a micro-CVD (chemical vapor deposition) or micro-sputtering device for depositing an insulating film or a metal film at the back plate abnormal point.

The above are merely the preferred embodiments of the present disclosure. It should be appreciated that, a person skilled in the art may make further modifications and improvements without departing from the principle of the present disclosure, and these modifications and improvements shall also fall within the scope of the present disclosure.

1. A method for testing an organic light-emitting diode (OLED) display device, comprising steps of:
applying a testing signal to the to-be-tested OLED display device;
acquiring a measured distribution image for a testing region of the OLED display device to which the testing signal is applied;
comparing the measured distribution image with a corresponding calibrated distribution image so as to obtain a comparison result;
determining whether or not there is a back plate abnormal point at the testing region in accordance with the comparison result; and
when the comparison result indicates that there is a back plate abnormal point at the testing region, determining a position of the back plate abnormal point on the OLED display device.

2. The method according to claim 1, wherein the measured distribution image is an infrared spectrum distribution image or a heat distribution image.

3. The method according to claim 1, wherein the step of acquiring the measured distribution image for the testing region of the OLED display device to which the testing signal is applied comprises:
dividing the testing region of the OLED display device into a plurality of detection regions; and
acquiring the measured distribution images for the detection regions sequentially.

4. The method according to claim 1, wherein the testing region of the OLED display device is a single detection region.

5. The method according to claim 1, wherein the testing region of the OLED display device is a pixel region of the OLED display device, or a combined region consisting of a pixel region of the OLED display device and a peripheral circuit region of the OLED display device.

6. The method according to claim 1, wherein the calibrated distribution image is a theoretical distribution image for a standard OLED display device to which the testing signal is applied, and
the standard OLED display device is of a structure identical to the to-be-tested OLED display device, and free of circuit defects.

7. The method according to claim 1, wherein the calibrated distribution image is a distribution image for a standard OLED display device to which the testing signal is not applied, and
the standard OLED display device is of a structure identical to the to-be-tested OLED display device, and free of circuit defects.

8. The method according to claim 1, wherein the calibrated distribution image is a distribution image for the to-be-tested OLED display device to which the testing signal is not applied.

9. The method according to claim 8, wherein prior to the step of applying the testing signal to the to-be-tested OLED display device, the method further comprises steps of:
acquiring a distribution image for the testing region of the OLED display device; and
taking the distribution image as the calibrated distribution image and storing the calibrated distribution image.

10. The method according to claim 1, wherein prior to the step of applying the testing signal to the to-be-tested OLED display device, the method further comprises steps of:
placing the OLED display device onto a testing platform;
acquiring an alignment mark of the OLED display device by an imaging device;
aligning the OLED display device in accordance with the alignment mark; and
attaching an OLED circuit emulation board onto the OLED display device.

11. The method according to claim 1, wherein the step of determining the position of the back plate abnormal point on the OLED display device comprises:
acquiring an alignment mark of the to-be-tested OLED display device acquired by an imaging device during an alignment, generating a coordinate system of the to-be-tested OLED display device in accordance with the alignment mark, and when it is determined that there is a back plate abnormal point in the measured distribution image, determining the position of the back plate abnormal point on the OLED display device in accordance with the coordinate system.

12. The method according to claim 1, wherein when the comparison result indicates that there is a back plate abnormal point at the testing region, the method further comprises a step of:
marking the back plate abnormal point in the measured distribution image.

13. The method according to claim 1, wherein when the comparison result indicates that there is a back plate abnormal point at the testing region, the method further comprises steps of:
matching image information about the back plate abnormal point in the measured distribution image with a previously stored back plate abnormal point information base,
preliminarily determining a cause for the back plate abnormal point, and
outputting the cause.

14. The method according to claim 1, wherein subsequent to the step of determining the position of the back plate abnormal point on the OLED display device, the method further comprises a step of:
moving a microscope device to the position for observation.

15. The method according to claim 1, wherein the OLED display device is an OLED thin film transistor (TFT) back plate, or an evaporated or printed OLED display panel, or an OLED display module where the circuit assembly has been finished.

16. A system for testing an organic light-emitting diode (OLED) display device, comprising:
a testing signal applying device, configured to apply a testing signal to the to-be-tested OLED display device;
an imaging device, configured to acquire and display a measured distribution image for a testing region of the OLED display device to which the testing signal is applied; and
a processor, configured to compare the measured distribution image with a corresponding calibrated distribution image so as to obtain comparison result, determine whether or not there is a back plate abnormal point at the testing region in accordance with the comparison result, and when the comparison result indicates that there is a back plate abnormal point at the testing region, determine a position of the back plate abnormal point on the OLED display device.

17. The system according to claim 16, wherein the imaging device is a charge coupled device (CCD) imager capable of acquiring heat information or infrared information.

18. The system according to claim 16, further comprising:
a testing platform,
wherein the imaging device is further configured to acquire an alignment mark of the OLED display device placed on the testing platform, and the processor is further configured to align the OLED display device in accordance with the alignment mark.

19. The system according to claim 16, further comprising:
a microscope device; and
a controller, configured to move the microscope device to the position for observation.
